(19) United States
(12) Patent Application Publication
(10) Pub. No.: US 2020/0002520 A1
(43) Pub. Date: Jan. 2, 2020

(54) MATERIAL MIXTURE FOR A SEALING PART

(71) Applicant: Semperit AG Holding, WIEN (AT)

(72) Inventors: Januszó Ledzinski, Polanica Zdrój (PL); Armin Holzner, Ternitz (AT); Ralf Supplit, WIENER NEUSTADT (AT)

(21) Appl. No.: 16/482,139

(22) PCT Filed: Jan. 24, 2018
(86) PCT No.: PCT/EP2018/051621

§ 371 Date: Jul. 30, 2019

(30) Foreign Application Priority Data
Jan. 31, 2017 (DE) 10 2017 101 817.4

(51) Int. Cl. C08L 23/16; C08L 23/08; B29C 65/00; E06B 7/23; F16J 15/10

(52) U.S. Cl. CPC C08L 23/16; C08L 23/0815; B29C 66/71; B29C 66/73755; B29C 66/73921; B29C 66/919; B29C 65/20; E06B 7/2314; F16J 15/102; C08L 2207/04; C08L 2205/06; C08L 2312/00; C08L 2205/025; E06B 7/2301

(57) ABSTRACT

Gasket profile made of a materials mixture which includes from 5 to 60% by volume of elastomer, from 8 to 50% by volume of copolymer, from 5 to 70% by volume of filler, from 0 to 40% by volume of plasticizer, from 0.1 to 5% by volume of accelerator/sulfur donor, from 0 to 5% by volume of sulfur, from 0 to 5% by volume of peroxide, and from 0 to 3% by volume of zinc oxide, where the copolymer is a thermoplastic or a thermoplastic elastomer.

### BACKGROUND OF THE INVENTION

The present invention relates to a materials mixture for a gasket profile, in particular for window gasket profiles and door gasket profiles, and also to a process for the production of the gasket profile, and to a construction element, in particular for a window element or for a door element, which comprises the gasket profile.

Materials used in the prior art for gasket profiles are primarily elastomer materials: by way of example, elastomer gasket profiles are drawn into PVC window profiles and can then be adhesive-bonded. It is disadvantageous that the adhesive-bonding requires an additional operation and therefore incurs higher costs. If the mitered gasket profiles are not adhesive-bonded, however, passage of time leads to formation of a gap into which, for example, rainwater can penetrate, because the gasket profiles shrink during their usage time. Welding of elastomer gasket profiles is not possible because crosslinking prevents these from softening (melting). Thermoplastic gaskets (TPE) have increasingly been used hitherto in order to avoid this problem; they can be welded to one another in a single operation with the PVC window profile. Thermoplastic gaskets, however, have associated disadvantages in terms of costs, processability, lifetime, etc. There has therefore long been a desire for a gasket profile made of a material, or of a materials mixture, which can be described as, and processed as, elastomer and has elastomer properties, while at the same time being weldable.

The patent application DE 10 2013 209 608 discloses a gasket profile made of a materials mixture which is crosslinked by way of sulfur and accelerator/sulfur donor. Although this gasket profile exhibits elastomer properties and can also be welded, the elastomer properties of this gasket profile exhibit disadvantages in relation to the following properties: compression set, reversion resistance, and aging.

Compression set (CS) is a measure of the behavior of elastomers on exposure to long periods of constant compression followed by removal of pressure. A CS of 100% indicates total deformation of the product. If CS is excessive, the pressure exerted decreases sharply, as also therefore does the sealing action, and leaks therefore arise.

The term reversion means a decrease of the degree of crosslinking and of mechanical-property values of vulcanizates (for example tensile strength, tear resistance, elasticity) when vulcanization is continued beyond the optimum. Improved reversion resistance leads to the possibility of using higher vulcanization temperatures without impairment of vulcanization properties, e.g. modulus.

Aging of material is another cause of leaks in gasket profiles.

It is therefore an object of the present invention to provide a gasket profile made of a materials mixture, and also a process for production of a construction element with use of the gasket profile, where the elastomeric properties or the elastomer properties of the gasket profile are improved while the weldability of the gasket profile is not impaired.

### SUMMARY OF THE INVENTION

A materials mixture for gasket profiles in the invention, in particular for window gasket profiles and door gasket profiles, has the following composition:
elastomer about 5 to 60% by volume, preferably 10 to 50% by volume,
copolymer about 8 to 50% by volume, preferably 15 to 40% by volume,
filler about 5 to 70% by volume, preferably 25 to 40% by volume,
plasticizer about 0 to 40% by volume, preferably 10 to 30% by volume,
accelerator/sulfur donor about 0.1 to 5% by volume,
sulfur about 0 to 5% by volume, preferably 0.05 to 0.5% by volume, particularly preferably 0.05 to <0.2% by volume,
peroxide about 0 to 5% by volume, preferably 0.05 to 4% by volume, particularly preferably 0.1 to 3% by volume,
zinc oxide about 0 to 3% by volume, preferably 0.2 to 2% by volume.

The elastomer fraction in this materials mixture is preferably an ethylene-propylene-diene rubber (EPDM). EPDM has very good aging resistance, weathering resistance and UV resistance, and also good resilience and excellent performance in respect of temperature changes. EPDM is therefore particularly suitable for window gasket profiles and door gasket profiles.

For the purposes of this invention, the elastomers are crosslinkable both by sulfur and/or accelerator/sulfur donor and by peroxide.

The copolymer is advantageously ethylene-propylene rubber (EPM), a thermoplastic or a thermoplastic elastomer (TPE). In contrast to elastomers, thermoplastic elastomers can be melted. The copolymer in the materials mixture of the present invention is advantageously not crosslinkable by sulfur and/or accelerator/sulfur donor, nor has any linkage sites and/or branching sites for the sulfur crosslinking agents. By way of example, EPM (which comprises no double bonds) cannot be crosslinked by using sulfur and/or sulfur-accelerator systems, but only with the aid of peroxides. The copolymer is advantageously a copolymer involving various alkenes, e.g. ethene, propene, butene, octene, etc.

In a preferred embodiment, the copolymer is selected from the group consisting of ethylene-octene copolymer, ethylene-butene copolymer or propylene-ethylene copolymer. By way of example, it is possible to use a Versify™ 2300 copolymer from Dow Chemical Company. It is of course also possible to achieve the advantages mentioned by using other copolymers or copolymer mixtures, and the copolymer is therefore not restricted to the above examples.

In a preferred embodiment, the elastomer is EPDM and the copolymer is EPM. This mixture has good properties of elasticity and strength, while at the same time the mixture is resistant to low temperatures, resistant to abrasion, and also resistant to aging, ozone and weathering.

The materials mixture is moreover characterized in that it comprises filler, and that the fill level can be higher than in TPE/TPV. Examples of possible fillers are carbon blacks, carbon fibers, mineral fillers such as calcium carbonate or talc, glass fibers, etc., and also mixtures of the materials mentioned. The filler advantageously has reinforcing effect (in order to achieve adequate mechanical properties), while the elastomer fraction provides the strength and elasticity. The fill level is preferably in a range of about 5 to 70%, preferably about 30 to 40%.

The materials mixture of the invention is characterized in that it comprises a crosslinking agent and preferably a combination of crosslinking agents, i.e. sulfur and/or accelerator/sulfur donor and/or peroxide.

In one embodiment, the materials mixture is characterized in that the crosslinking agent is accelerator/sulfur donor.

In a preferred embodiment, the materials mixture of the invention comprises a crosslinking agent combination made of accelerator/sulfur donor and peroxide, or made of sulfur, accelerator/sulfur donor and peroxide. Although sulfur crosslinking and peroxide crosslinking are known from the literature (see by way of example WO 2008/094741), no hybrid combinations of crosslinking agents are known for gaskets. In the case of crosslinking by sulfur alone or by peroxide alone, the degree of crosslinking and/or the crosslinking density is/are dependent on the nature and quantity of the crosslinking system selected. The crosslinking density here has a decisive effect on the properties of the gasket profile, for example fatigue, hardness, tensile strength, residual deformation, and also frictional properties and elongation at break. Crosslinking density should be selected in a manner such that the gasket profile of the invention has the desired properties. Crosslinking of the abovementioned materials mixture is preferably achieved with a hybrid combination of peroxide and sulfur and/or accelerator/sulfur donor, and specifically preferably after shaping. In particular, the proportion of peroxide crosslinking agent in a sulfur/peroxide hybrid combination in terms of the sulfur/peroxide ratio in the materials mixture is between 1 and 95%, preferably 2 and 50%, particularly preferably 5 and 20%, and ideally is 15%. Crosslinking is advantageously achieved at a temperature in a range of about 150-250° C. Standard crosslinking methods known from elastomer processing can be used, for example vulcanization at 210° C. in a salt bath.

Hybrid combinations of peroxide and sulfur and/or accelerator/sulfur donor can be used, instead of crosslinking by sulfur alone or by peroxide alone, to achieve the following: elimination or significant reduction of the reversal of vulcanization at high temperatures, identical or improved physical properties, increased aging resistance, in particular retention of elongation at break, and also improved compression set.

The following can be used as plasticizers: paraffinic mineral oils, naphthene-based or aromatic oils, or else synthetic oils, for example diisononyl 1,2-cyclohexane-dicarboxylate.

The materials mixture can optionally also comprise zinc oxide. Addition of zinc oxide can activate the sulfur crosslinking system and improve the heat resistance of the materials mixture.

A gasket profile of this type is preferably used in the field of windows, doors, facades and gates. Gasket profiles of this type are likewise used in what is known as downstream frame manufacture with gasket profiles; by way of example here, gasket profiles are mitered and welded.

A gasket profile, in particular for window gaskets and door gaskets, is produced in the invention via the following steps from a materials mixture:
mixing of the materials mixture;
molding of the materials mixture;
crosslinking of the materials mixture.

A multistage mixing method can preferably also be used. In this, the elastomer fraction and the copolymer fraction are mixed in a first step, preferably in an elastomer:copolymer ratio of 2:1, thus producing a mix. The first mix is then mixed with fillers, plasticizers and zinc oxide to give a second mix. In a further step, the second mix is mixed with accelerator/sulfur donor and/or sulfur and/or peroxide, thus producing a third mix. It is preferable that the ratio of elastomer/copolymer, i.e. of the first mixture, to the remaining constituents of the materials mixture is 1:1, preferably 1:2. The condition of the materials mixture in the third mix is thus one in which both the elastomer fraction and the copolymer fraction are uncrosslinked. Accordingly, the materials mixture is then deformable and/or can be deformed. The crosslinking takes place only after shaping, preferably with exposure to heat. Advantageously the materials mixture is a cross-linked mixture with uncrosslinked regions or else segments, and is thus weldable. In this process, the copolymer is not crosslinked, or is crosslinked only to a small extent, and can therefore melt during heating/welding. Since the elastomer fraction has been crosslinked, no significant deformation occurs here (bead). The melt of, for example, two gasket profiles welded to one another can mix at the contact site, thus producing a strong bond. In other words, the materials mixture comprises, after crosslinking, crosslinked elastomer content and non-crosslinked copolymer content. Elastomer properties are determined here by the crosslinked regions. The materials mixture does not involve a thermoplastic polymer (TPE), since the mixture can no longer be deformed by exposure to heat.

Nor is the materials mixture a traditional thermoplastic elastomer (TPE) such as PP/EPDM (propylene/ethylene-propylene-diene rubber, also known as TPV). These materials, e.g. TPV, are materials with elastic polymer chains (crosslinked EPDM) bound (dispersed) in thermoplastic material (PP). They can be processed in a purely physical procedure in combination with exposure to heat followed by cooling. No chemical crosslinking due to exposure to heat therefore takes place after shaping. This type of material can be milled and reprocessed. During production of a TPE, the material is extruded, and dimensional stability is obtained by cooling of the material.

After shaping (extrusion), the materials mixture of the invention is not cooled, but instead is crosslinked by heating. Advantageously the materials mixture remains dimensionally stable at relatively high temperatures, whereas at the same temperatures by way of example a TPE made of PP/EPDM melts and can undergo change of shape. The materials mixture exhibits no thermoplastic behavior, because it can no longer be deformed by exposure to heat.

The materials mixture of the invention involves, in the mixture, an uncrosslinked elastomer (elastomer fraction) and a copolymer. The crosslinking takes place after shaping, advantageously through exposure to heat (in a manner similar to that for elastomers). Advantageously the materials mixture does not melt in the manner of a thermoplastic on exposure to heat, but is nevertheless weldable. It is thus possible to use processing methods which are the same as those used for conventional elastomer products; it is thus possible to produce coextrudates of this weldable material with elastomer products. Advantageously the elastomer fraction is uncrosslinked during the mixing procedure and the molding procedure.

Advantageously the materials mixture is characterized in that, after crosslinking, the materials mixture is weldable to, and/or has been welded to, itself and/or an elastomer material. The great advantage is that, after crosslinking, the materials mixture is, in a manner of speaking, a chemically crosslinked elastomer that is weldable. The elasticity and strength obtained during welding can advantageously be adjusted by way of the ratio of elastomer fraction to copolymer fraction. The materials mixture can by way of example be welded in a single operation during the manufacture of a window frame or door frame. Mitered PVC window frames or mitered PVC door frames are generally welded by using a hot plate welding tool. It is now advantageously possible that, at the same temperature and in the same operation in which the window frames or door frames are bonded/welded, the gasket profiles which have been drawn into the window frames or door frames and which have been manufactured from the materials mixture are likewise welded to one another.

Advantageously the materials mixture is characterized in that it is weldable at a temperature of about 150° to 300° C. The welding particularly preferably takes place at a temperature of about 180 to 260° C. Welding of the materials mixture can thus advantageously take place in a single operation with the welding of a window frame, for example made of PVC.

The materials mixture is preferably characterized in that the copolymer addition advantageously exhibits uncross linked segments or regions, which provides and/or forms weldability. Advantageously the segments or regions formed by the copolymer can melt during heating.

Mixing advantageously takes place in an internal mixer up to about 150° C., preferably with a plurality of mixing stages. It is important that the temperature during the admixing of the crosslinking agents is not permitted to become excessive, since otherwise crosslinking of the materials mixture would already begin in the mixer. However, the crosslinking takes place only after shaping with exposure to heat.

The invention provides a construction element, in particular a window element or a door element, which comprises a gasket profile manufactured from the gasket profile of the invention, where two components of the construction element (e.g. frame profiles) and the corresponding gasket profiles can be bonded in the same operation. The bonding is preferably achieved via coherent bonding, for example via welding with use of a hot plate welding tool. The material of the component is advantageously by way of example PVC. It is thus advantageously possible in a single operation to weld at least two components and their gasket profiles (e.g. placed therein) respectively to one another, i.e. to weld the two components to one another and the two gasket profiles to one another.

The invention provides a process comprising the steps of:
provision of at least two components, for example window frame (profiles) or door frame (profiles);
provision of at least two gasket profiles made of the materials mixture of the invention;
drawing of the gasket profiles into the corresponding components;
welding of the components and of the gasket profiles to one another in a single operation.

Individual features of the embodiments described can of course be combined with one another. In particular, it should be noted that the advantages and features of the materials mixture also apply to the materials mixture produced by the process of the invention and to the process of the invention and to the construction element of the invention; this is also the case in reverse sequence and for any combination of the above.

1.-12. (canceled)

13. A gasket profile for window gasket profiles and door gasket profiles, comprising a materials mixture that comprises:
from 5 to 60% by volume of EPDM;
from 8 to 50% by volume of copolymer;
from 5 to 70% by volume of filler;
from 0 to 40% by volume of plasticizer;
from 0.1 to 5% by volume of accelerator/sulfur donor;
from 0 to 5% by volume of sulfur;
from 0.05 to 5% by volume of peroxide; and
from 0.05 to 3% by volume of zinc oxide;
where the copolymer is a thermoplastic or a thermoplastic elastomer.

14. The gasket profile as claimed in claim 13, where a ratio of EPDM to copolymer in the materials mixture is 2:1.

15. The gasket profile as claimed in claim 14, where the EPDM is crosslinkable both by sulfur and/or accelerator/sulfur donor and by peroxide.

16. The gasket profile as claimed in claim 15, where the copolymer is not sulfur-crosslinkable.

17. The gasket profile as claimed in claim 16, where the copolymer is crosslinkable by peroxides.

18. The gasket profile as claimed in claim 17, where the copolymer is a propylene-ethylene copolymer, an ethylene-butene copolymer, an ethylene-octene copolymer or an ethylene-propylene copolymer.

19. The gasket profile as claimed in claim 18, where the proportion of peroxide of the sulfur/peroxide ratio is between 1% and 95%.

20. The gasket profile as claims in claim 19, wherein the proportion of the sulfur/peroxide ratio is between 2% and 50%.

21. The gasket profile as claims in claim 20, wherein the proportion of the sulfur/peroxide ratio is between 5% and 20%.

22. The gasket profile as claims in claim 21, wherein the proportion of the sulfur/peroxide ratio is 15%.

23. The gasket profile as claimed in claim 13, wherein the materials mixture is weldable at a temperature of about 150° C. to 300° C.

24. The gasket profile as claimed in clam 23, wherein the materials mixture is weldable at a temperature of about 180° C. to 260° C.

25. The gasket profile as claimed in claim 13, where the EPDM is crosslinkable both by sulfur and/or accelerator/sulfur donor and by peroxide.

26. The gasket profile as claimed in claim 13, where the copolymer is not sulfur-crosslinkable.

27. The gasket profile as claimed in claim 13, where the copolymer is crosslinkable by peroxides.

28. The gasket profile as claimed in claim 13, where the copolymer is a propylene-ethylene copolymer, an ethylene-butene copolymer, an ethylene-octene copolymer or an ethylene-propylene copolymer.

29. The gasket profile as claimed in claim 13, where the proportion of peroxide of the sulfur/peroxide ratio is between 1% and 95%.

30. A process for the production of a door element or a window element, comprising:
providing at least two components including window profiles or door profiles;
providing at least two gasket profiles as claimed in claim 13, where the materials mixture has been mixed and molded and has then been crosslinked with exposure to heat;
drawing of the gasket profiles into the corresponding components; and
welding of the components and of the gasket profiles to one another in a single operation.

31. The process as claimed in claim 30, where the components and the gasket profile are welded at a temperature of about 150° C. to 300° C.

32. The process as claimed in claim 31, where the components and the gasket profile are welded at a temperature of about 180° C. to 260° C.
